(19) United States
(12) Patent Application Publication
(10) Pub. No.: US 2011/0063586 A1
(43) Pub. Date: Mar. 17, 2011

(54) PROJECTION DISPLAY DEVICE

(75) Inventors: Ryuhei AMANO, Hirakata City (JP); Takashi IKEDA, Higashi Osaka City (JP)

(73) Assignee: SANYO ELECTRIC CO., LTD, Moriguchi City (JP)

(21) Appl. No.: 12/950,542

(22) Filed: Nov. 19, 2010

Related U.S. Application Data
(63) Continuation of application No. PCT/JP2009/058552, filed on May 1, 2009.

(30) Foreign Application Priority Data
May 22, 2008 (JP) 2008-134479

(51) Int. Cl. G03B 21/28

(52) U.S. Cl. 353/99

(57) ABSTRACT

A projection display device includes: an optical engine that emits image light in a direction parallel to a projection plane; a first reflective optical system that reflects the image light in a first direction away from the projection plane; a second reflective optical system that reflects the image light reflected by the first reflective optical system in a second direction away from the optical engine and closer to the projection plane; and a refractive optical system. The refractive optical system is divided into a first refractive optical system interposed between the optical engine and first reflective optical system, and second refractive optical system interposed between the first and second reflective optical system. The optical engine is arranged so that a mounting plane of optical components is almost perpendicular to a plane parallel to both of the first and second directions and is almost parallel to the projection plane.

This application claims priority under 35 U.S.C. Section 119 of Japanese Patent Application No. 2008-134479 filed May 22, 2008, entitled “PROJECTION DISPLAY DEVICE”. The disclosure of the above application is incorporated herein by reference.

### BACKGROUND OF THE INVENTION

1. Field of the Invention

The present invention relates to projection display devices that enlarge and project an image in an imager onto a projection plane, and is in particular suitable for use in projection display devices that project light in an oblique direction onto the projection plane.

2. Disclosure of Related Art

There have been commercialized and widely used projection display devices (hereinafter, referred to as “projectors”) that enlarge and project an image in an imager such as a liquid crystal panel onto a projection plane (a screen or the like). Among this type of projectors, there has been proposed a projector performing oblique projection in which a projection optical system forms a wider angle and a traveling direction of projection light is tilted relative to a light axis of the projection optical system, thereby to shorten a distance between a screen and the projector body.

The projector of oblique projection can be realized by using a projection lens unit (refractive optical system) and a mirror (reflective optical system) as a projection optical system, for example. In this configuration, an image in an imager is formed as an intermediate image between the projection lens unit and the mirror, and the intermediate image is enlarged and projected by the mirror. According to this configuration, a wide angle can be realized by a comparatively small curved mirror, thereby suppressing cost increase and upsizing of the projector body.

If the foregoing projection optical system is applied to a projector, the projector may be configured as shown in FIGS. 18A and 18B, for example. FIG. 18A shows a projector installed to project an image onto a desktop or a floor surface. FIG. 18B shows a projector installed to project an image onto a wall surface or a screen.

A casing 1000 contains an optical engine 1100 that generates image light modulated in accordance with an image signal. The generated image light is entered into a refractive optical system 1200. The image light having passed through the refractive optical system 1200 is reflected and converged by a reflective mirror 1500.

The reflective mirror 1500 has an aspherical or free-form concave reflecting surface, and is shifted opposite to a projection window 1400 from a light axis L of the refractive optical system 1200. The image light reflected by the reflective mirror 1500 passes through the projection window 14, and then is projected at a wider angle onto the projection plane.

In this configuration, a size of a projected image (hereinafter, referred to as “projection size”) is increased or decreased by changing a distance between the projector and the projection plane. The projection size can be increased by moving the projector away from the projection plane.

In the foregoing projector, a distance between a final optical component of the projection optical system (the reflective mirror 1500 in FIGS. 18A and 18B) and the projection plane (hereinafter, referred to as “throw distance”) is desirably made short as much as possible, for the following reason as an example.

Specifically, the shorter throw distance, the light projected from the projection window 1400 becomes less prone to be cut off by an obstacle, which makes it easy to suppress occurrence of shades on a projected image. In addition, the shorter throw distance with the projector closest to the projection plane (minimum throw distance), a lower limit of the projection size can be further decreased. This widens a range of projection size that can be adjusted by moving the projector closer to or away from the projection plane.

However, in the configuration of FIGS. 18A and 18B, the optical engine 1100, the refractive optical system 1200, and the reflective mirror 1500 are arranged in line parallel to a plane on which optical components are mounted in the optical engine 1100, whereby a size D of the projector body is longer in the direction of arrangement of these three components. Therefore, a throw distance H becomes long even if the projector is made closest to the projection plane, as shown in FIGS. 18A and 18B.

Besides, in the foregoing configuration, an outer shape of the projector body is prolonged in the above-mentioned direction of arrangement, and therefore the projector loses postural stability and is apt to tumble when the projector is installed for projection onto a floor surface, as shown in FIG. 18A.

### SUMMARY OF THE INVENTION

A projection display device in a first aspect of the present invention includes: an optical engine that emits image light modulated in accordance with an image signal in a direction parallel to a projection plane or in a direction tilted relative to the projection plane at a predetermined angle; a first reflective optical system that reflects the image light in a first direction away from the projection plane; a second reflective optical system that reflects the image light reflected by the first reflective optical system in a second direction away from the optical engine and closer to the projection plane, thereby to enlarge and project image light onto the projection plane; and a refractive optical system that is interposed between the optical engine and the second reflective optical system. Here, the refractive optical system is divided into a first refractive optical system interposed between the optical engine and the first reflective optical system, and a second refractive optical system interposed between the first reflective optical system and the second reflective optical system. In addition, the optical engine is arranged in such a manner that a mounting plane of optical components is almost perpendicular to a plane parallel to both of the first and second directions and is almost parallel to the projection plane.

A projection display device in a second aspect of the present invention includes: an optical engine that emits image light modulated in accordance with an image signal in a direction parallel to a projection plane or in a direction tilted relative to the projection plane at a predetermined angle; a first reflective optical system that reflects the image light in a first direction away from the projection plane; a second reflective optical system that reflects the image light reflected by the first reflective optical system in a second direction away from the optical engine and closer to the projection plane, thereby to enlarge and project image light onto the projection plane; and a refractive optical system that is interposed between the optical engine and the second reflective optical system. Here, the refractive optical system is divided into a first refractive optical system interposed between the optical engine and the first reflective optical system, and a second refractive optical system interposed between the first reflective optical system and the second reflective optical system. In addition, optical components constituting the optical engine are scattered in a direction that is almost perpendicular to a plane parallel to both of the first and second directions and is almost parallel to the projection plane.

A projection display device in a third aspect of the present invention includes: an optical engine that emits image light modulated by a micro mirror element in accordance with an image signal in a direction parallel to a projection plane; a first reflective optical system that reflects the image light in a first direction away from the projection plane; a second reflective optical system that reflects the image light reflected by the first reflective optical system in a second direction away from the optical engine and closer to the projection plane, thereby to enlarge and project image light onto the projection plane; and a refractive optical system interposed between the optical engine and the second reflective optical system. Here, the refractive optical system is divided into a first refractive optical system that is interposed between the optical engine and the first reflective optical system, and a second refractive optical system that is interposed between the first reflective optical system and the second reflective optical system. In addition, the micro mirror element is arranged such that a longer side thereof is almost perpendicular to a plane parallel to both of the first and second directions and is almost parallel to the projection plane.

### BRIEF DESCRIPTION OF THE DRAWINGS

The foregoing and other objects and novel features of the present invention will be more fully understood from the following description of a preferred embodiment when reference is made to the accompanying drawings.

FIGS. 1A and 1B are diagrams showing a configuration of a projector in an embodiment of the present invention;

FIGS. 2A and 2B are diagrams showing usage patterns of the projector in the embodiment;

FIGS. 3A and 3B are diagrams for describing that a minimum throw distance H becomes shorter depending on an orientation of a mounting plane of an optical engine in the embodiment;

FIGS. 4A and 4B are diagrams showing a configuration of the projector in a modification example 1;

FIGS. 5A and 5B are diagrams showing a configuration of the projector in a modification example 2;

FIGS. 6A and 6B are diagrams showing a configuration of the projector in a modification example 3;

FIGS. 7A and 7B are diagrams showing a configuration of the projector in a modification example 4;

FIGS. 8A and 8B are diagrams showing an integrated configuration of a refractive optical system and a reflective mirror;

FIG. 9 is a diagram showing an integrated configuration of the refractive optical system, the reflective mirror, and a curved mirror;

FIGS. 10A, 10B, and 10C are diagrams showing a configuration of a projector in another modification example;

FIGS. 11A and 11B are diagrams showing a configuration of a shift module in another modification example, and a structure of attachment of an imager unit and a projection optical unit to the shift module;

FIGS. 12A and 12B are diagrams showing a configuration of a shift mechanism (a fixing member, a displacement mechanism section, and a linear guide) in another modification example;

FIGS. 13A and 13B are diagrams showing a configuration of the fixing member in another modification example;

FIGS. 14A, 14B, 14C, and 14D are diagrams for describing a shift operation of the shift mechanism in another modification example;

FIGS. 15A and 15B are diagrams for describing transformation examples of the optical engine (configuration examples 1 and 2);

FIGS. 16A, 16B, 16C, and 16D are diagram for describing transformation examples of the optical engine (configuration examples 3 and 4);

FIGS. 17A and 17B are diagrams for describing a transformation example of the optical engine (configuration example 5); and

FIGS. 18A and 18B are diagrams showing a configuration of a projector in a related art.

However, the drawings are only for purpose of description, and do not limit the scope of the present invention.

### DESCRIPTION OF PREFERRED EMBODIMENTS

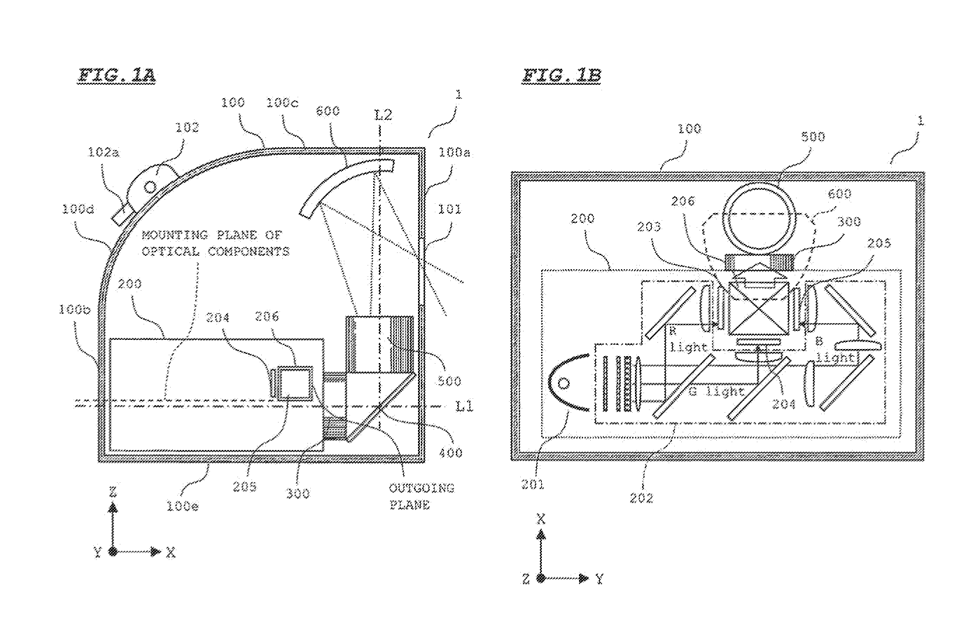

An embodiment of the present invention will be described below with reference to the drawings. FIGS. 1A and 1B are diagrams showing an internal structure of a projector 1 in this embodiment. FIG. 1A is an internal perspective view of the projector 1 as seen from a side. FIG. 1B is an internal perspective view of the projector 1 as seen from the top, which shows mainly a layout of optical components in an optical engine 200.

Referring to FIGS. 1A and 1B, the projector 1 includes a cabinet 100. The cabinet 100 has on a front surface 100a thereof an image light projection window 101. The cabinet 100 also has a convex curved surface 100d from a back surface 100b to an upper surface 100c thereof. The convex curved surface 100d is provided with a handle 102. The handle 102 has a grab section 102a that is rotatable in an X-Z in-plane direction. The handle 102 is also used as a stand for supporting the cabinet 100 when the projector 1 is installed for “wall projection,” as described later.

The cabinet 100 contains the optical engine 200, a rear refractive optical system 300, a reflective mirror 400 (equivalent to the first reflective optical system of the present invention), a front refractive optical system 500, and a curved mirror 600 (equivalent to the second reflective optical system of the present invention).

The optical engine 200 is arranged on a bottom surface of the cabinet 100 to generate image light modulated in accordance with an image signal. The optical engine 200 has optical components (liquid crystal panels, a dichroic prism, and the like) arranged in a predetermined layout within a casing thereof. A mounting plane of the optical components is approximately parallel to a bottom surface 100e of the cabinet 100.

As shown in FIG. 1B, the optical engine 200 includes a light source 201, a light-guiding optical system 202, three transmissive liquid crystal panels 203, 204, and 205, and a dichroic prism 206.

The light-guiding optical system 202 separates white light emitted from the light source 201 into a red-waveband light (hereinafter, referred to as “R light”), a green-waveband light (hereinafter, referred to as “G light”), and a blue-waveband light (hereinafter, referred to as “B light”), and then radiates the separated lights to the liquid crystal panels 203, 204, and 205. The liquid crystal panels 203, 204, and 205 modulate the R, G, and B lights, and then the dichroic prism 206 combines the modulated lights and emits the same as image light. In addition, polarizers (not shown) are disposed on incident sides and output sides of the liquid crystal panels 203, 204, and 205.

Instead of the transmissive liquid crystal panels 203, 204, and 205, imagers arranged in the optical engine 200 may use reflective liquid crystal panels or MEMS devices. In addition, the optical engine 200 may not be a three-plate optical system including three imagers as described above, but may be a single-plate optical system using one imager and a color wheel, for example.

The rear refractive optical system 300 is attached to an image light outgoing window of the optical engine 200. The rear refractive optical system 300 receives incident image light generated at the optical engine 200. The rear refractive optical system 300 includes a plurality of lenses. A light axis L1 of these lenses is parallel to the bottom surface 100e (X axis) of the cabinet 100. As shown in FIG. 1A, the liquid crystal panels 203, 204, and 205, and the dichroic prism 206 are shifted in a Z-axis direction (the curved mirror 600 side) from the light axis L1 of the rear refractive optical system 300.

The reflective mirror 400 is arranged in front of the rear refractive optical system 300. The reflective mirror 400 is arranged in such a manner as to be perpendicular to an X-Z plane and be tilted at 45 degrees relative to the bottom surface 100e of the cabinet 100 (X-Y plane).

The front refractive optical system 500 is arranged above the reflective mirror 400. The front refractive optical system 500 includes a plurality of lenses. A light axis L2 of these lenses is parallel to a Z axis and also is parallel to an image light outgoing plane of the dichroic prism 206. In addition, the light axis L2 of the front refractive optical system 500 is perpendicular to the light axis L1 of the rear refractive optical system 300 and the bottom surface 100e of the cabinet 100, and intersects the light axis L1 of the rear refractive optical system 300 on the reflective mirror 400. That is, the front refractive optical system 500 constitutes one refractive optical system in conjunction with the rear refractive optical system 300. In this constitution, the light axis of the lens group is converted from a direction perpendicular to the outgoing plane of the dichroic prism 206 to a direction parallel to the same, by the reflective mirror 400 interposed between these two refractive optical systems 300 and 500.

The image light entered into the rear refractive optical system 300 passes through the rear refractive optical system 300, the reflective mirror 400, and the front refractive optical system 500, and then enters the curved mirror 600 arranged above the front refractive optical system 500.

The curved mirror 600 has a concave reflecting surface. The curved mirror 600 includes an effective reflection area on the optical engine 200 side of the light axis L2 of the front refractive optical system 500, as shown in FIG. 1A. The curved mirror 600 may have an aspherical shape, a free-form shape, or a spherical shape.

The image light entered into the curved mirror 600 is reflected by the curved mirror 600, and is enlarged and projected onto the projection plane through the projection window 101. At that time, the image light is enlarged after being most converged near the projection window 101.

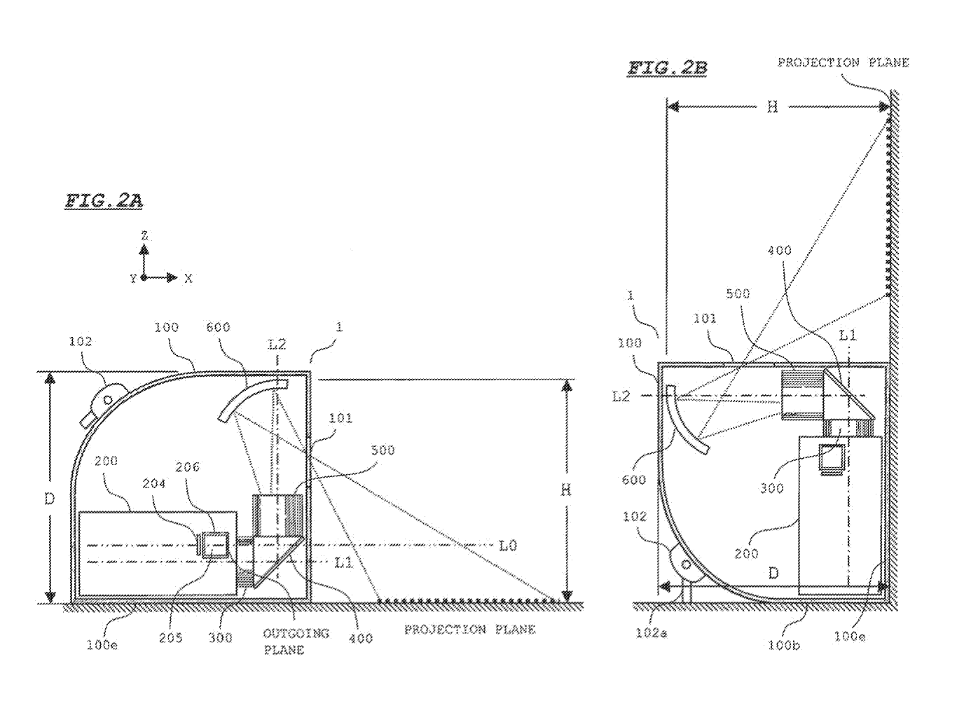

FIGS. 2A and 2B are diagrams showing usage patterns of the projector 1. FIG. 2A shows a usage pattern for projecting an image onto a desktop or a floor surface, and FIG. 2B shows a usage pattern for projecting an image onto a wall surface or a screen.

As shown in FIG. 2A, the projector 1 of this embodiment may be installed with the bottom surface 100e of the cabinet 100 on a desktop or a floor surface. This makes it possible to project an image onto the desktop or the floor surface as a projection plane. Hereinafter, this usage pattern will be referred to as “floor projection.”

In addition, as shown in FIG. 2B, the projector 1 of this embodiment may be installed with the back surface 100b of the cabinet 100 on a desktop or a floor surface. This makes it possible to project an image onto a wall surface or a screen. Hereinafter, this usage pattern will be referred to as “wall projection.” In this usage pattern, as shown in FIG. 2B, the projector 1 may also be installed with the bottom surface 100e tightly attached to a wall surface. Accordingly, in wall projection, the projector 1 can be supported on the back side by the grab section 102a of the handle 102, thereby preventing the projector 1 from falling down backward.

As shown in FIG. 2A, the curved mirror 600 and the projection plane are positioned opposite to each other across an axis L0 that passes through a center of the outgoing plane of the dichroic prism 206 and is perpendicular to the outgoing plane of the dichroic prism 206. In addition, the outgoing plane of the dichroic prism 206 and the projection plane are perpendicular to each other.

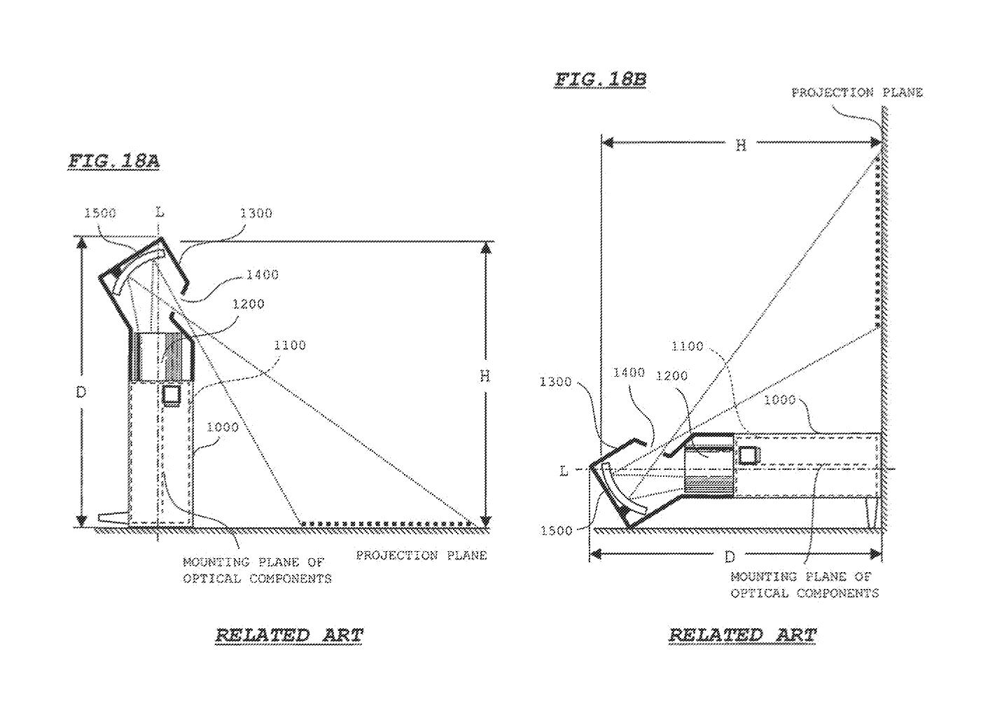

In this embodiment, unlike the projector shown in FIGS. 18A and 18B, the optical engine 200, the refractive optical systems 300 and 500, and the curved mirror 600 are not arranged in line in a direction parallel to the mounting plane of the optical components on the optical engine 200. Specifically, in this embodiment, the optical engine 200, the refractive optical systems 300 and 500, and the curved mirror 600 are arranged in an approximately L-shaped form within the cabinet 100.

Accordingly, as shown in FIGS. 2A and 2B, this embodiment allows the size D of the projector body to be reduced in the direction of the light axis L2 in which the reflective mirror 400 and the curved mirror 600 are aligned, thereby to shorten the throw distance H (minimum throw distance H) with the projector 1 closest to the projection plane. Therefore, it is easy to prevent that image light projected from the projection window 101 is cut off by an obstacle and that unnecessary shades are cast onto a projected image. In addition, since the lower limit of the projection size can be further decreased, the projection size can be adjusted within an increased range by making the projector 1 closer to or away from the projection plane.

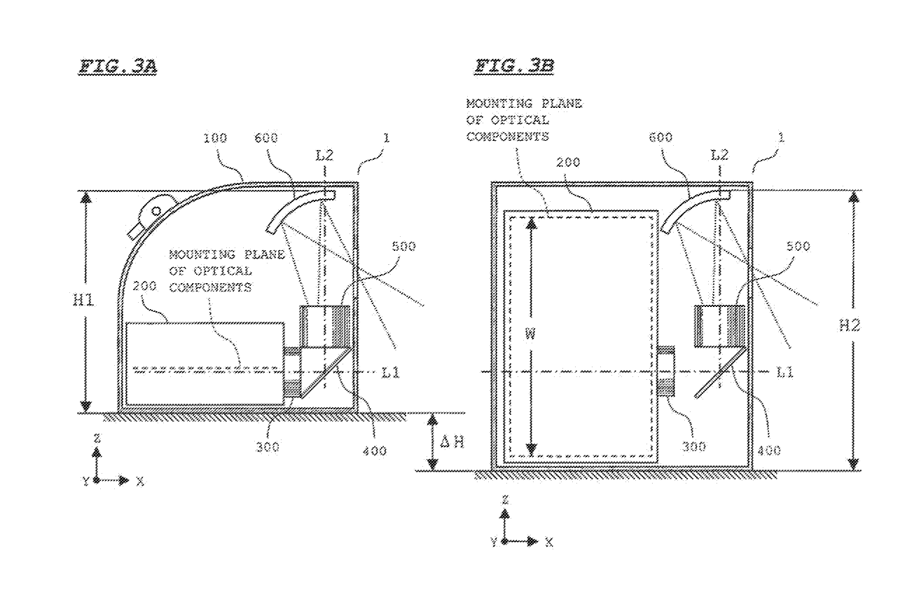

In this embodiment, as shown in FIG. 3A, the optical engine 200 is arranged in such a manner that the mounting plane of the optical components is perpendicular to a plane parallel to both the direction of reflection of image light by the reflective mirror 400 and the direction of reflection of image light by the curved mirror 600, that is, the mounting plane of the optical components is perpendicular to the X-Z plane in the drawing. Accordingly, a minimum throw distance H1 of the projector 1 can be readily made shorter without any influence of the width of the mounting plane. Specifically, as shown in FIG. 3B, if the optical engine 200 is arranged in such a manner the mounting plane of the optical components is parallel to the X-Z plane in the drawing, the minimum throw distance is influenced by a width W of the mounting plane, whereby the dimension of the optical engine 200 under the light axis L1 of the rear refractive optical system 300 becomes longer than that in this embodiment. Accordingly, a minimum throw distance H2 in this configuration becomes longer by ΔH than the minimum throw distance Hi of this embodiment. Meanwhile, in this embodiment, as shown in FIG. 3A, the mounting plane of the optical components is parallel to the X-Y plane in the drawing, which allows the minimum throw distance H1 of the projector 1 to be shortened without any influence of the width of the mounting plane.

Moreover, in this embodiment, the projector body can be formed in an almost cubic shape, which allows the projector 1 to be stably installed in the both usage patterns of floor projection and wall projection.

Further, in this embodiment, the reflective mirror 400 is interposed between the rear refractive optical system 300 and the front refractive optical system 500, thereby preventing a longer back focus of the refractive optical system.

Although the embodiment of the present invention is as described above, the embodiment of the present invention may be modified as described below.

### MODIFICATION EXAMPLE 1

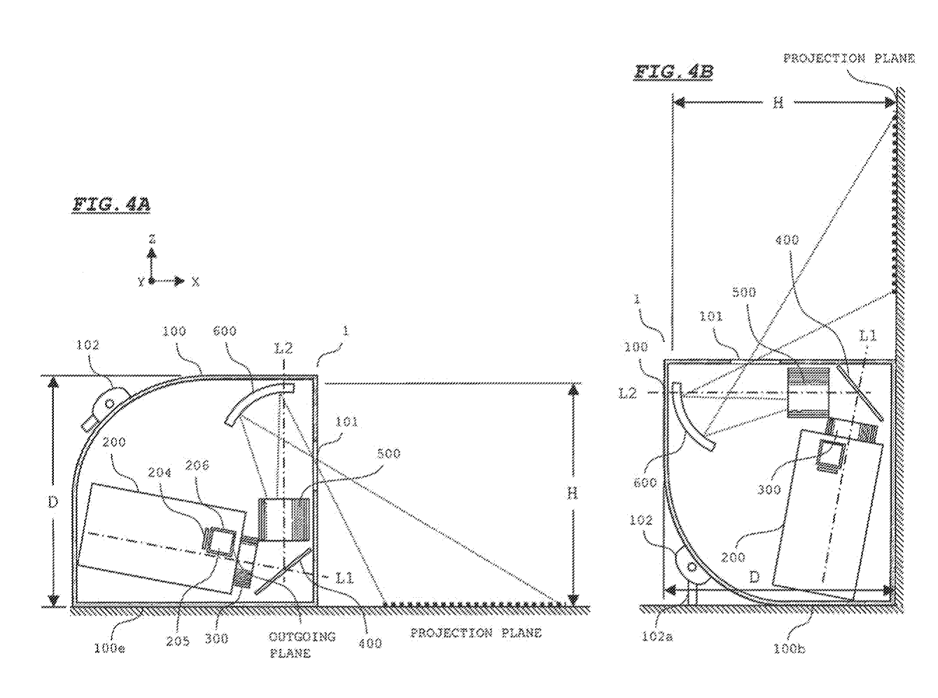

FIGS. 4A and 4B are diagrams showing a configuration of the projector 1 in modification example 1. FIG. 4A shows the projector 1 installed for “floor projection, ” and FIG. 4B shows the projector 1 installed for “wall projection.”

In the foregoing embodiment, the optical engine 200 and the rear refractive optical system 300 are arranged in parallel to the bottom surface 100e of the cabinet 100. Alternatively, the optical engine 200 and the rear refractive optical system 300 may be slightly tilted relative to the bottom surface 100e, as shown in FIGS. 4A and 4B. In this case, tilt of the reflective mirror 400 relative to the bottom surface 100e is made smaller in accordance with the tilt of the rear refractive optical system 300.

In such a configuration, the light axis L1 of the rear refractive optical system 300 and the light axis L2 of the front refractive optical system 500 are not perpendicular to each other, and the outgoing plane of the dichroic prism 206 and the projection plane are also not perpendicular to each other.

If an angle of the tilt relative to the bottom surface 100e is too large, part of the front refractive optical system 500 may interfere with the rear refractive optical system 300 or the optical engine 200. Therefore, the angle of tilt needs to be set so as not to cause such interference.

As described above, the optical engine 200 and the rear refractive optical system 300 may be tilted if necessary in the design of the projector 1. However, the tilt needs to be set such that part of the front refractive optical system 500 does not interfere with the rear refractive optical system 300 or the optical engine 200.

In the configuration of the modification example 1, as in the foregoing embodiment, it is possible to shorten the minimum throw distance H and install the projector 1 stably in the both usage patterns of floor projection and wall projection.

### MODIFICATION EXAMPLE 2

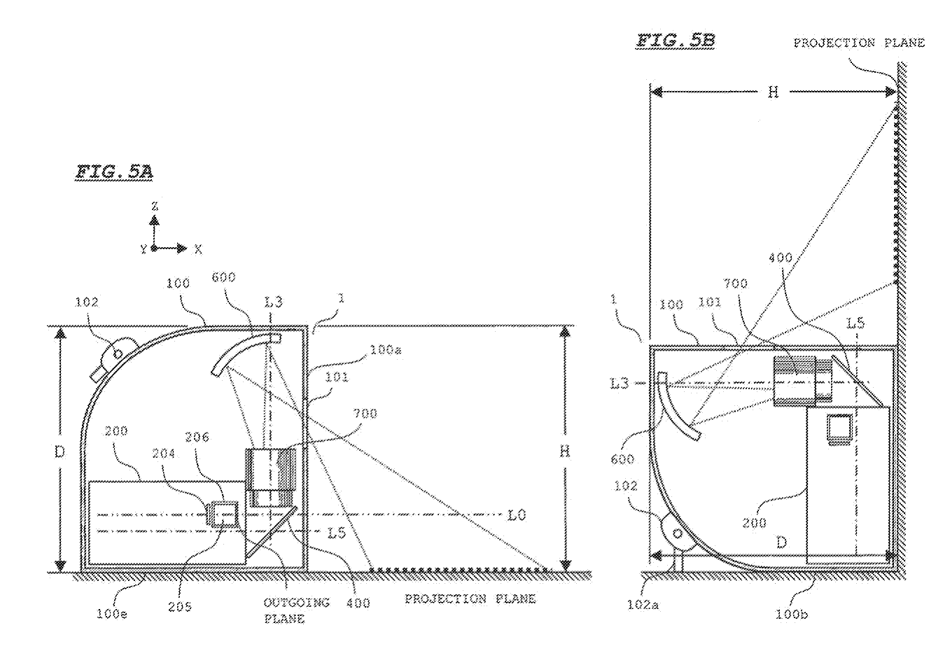

FIGS. 5A and 5B are diagrams showing a configuration of the projector 1 in a modification example 2. FIG. 5A shows the projector 1 installed for “floor projection, ” and FIG. 5B shows the projector 1 for “wall projection.”

In the foregoing embodiment, the refractive optical system is divided into the rear refractive optical system 300 and the front refractive optical system 500, with the reflective mirror 400 interposed therebetween.

Meanwhile, in the configuration of the modification example 2, as shown in FIG. 5A, the reflective mirror 400 is arranged in front of the optical engine 200, and a refractive optical system 700, instead of the rear refractive optical system 300 and the front refractive optical system 500, is arranged only above the reflective mirror 400. A light axis L3 of the refractive optical system 700 is parallel to a Z axis shown in FIG. 5A, that is, is parallel to the outgoing plane of the dichroic prism 206 and is perpendicular to the axis LO perpendicular to the outgoing plane. In addition, the liquid crystal panels 203, 204, 205, and the dichroic prism 206 are arranged above an axis L5 that is a turn-back of the light axis L3 from the reflective mirror 400 (the curved mirror 600 side). Image light emitted from the optical engine 200 is reflected by the reflective mirror 400 and is entered into the refractive optical system 700.

In the configuration of the modification example 2, as in the foregoing embodiment, it is possible to shorten the minimum throw distance H and install the projector 1 stably in the both usage patterns of floor projection and wall projection.

In addition, in the configuration of the modification example 2, the refractive optical system can be simplified as compared with the configuration where the reflective mirror 400 is interposed between the rear refractive optical system 300 and the front refractive optical system 500. Nevertheless, in the configuration of the modification example 2, the refractive optical system is distant from the optical engine, thereby prolonging a back focus of the refractive optical system.

### MODIFICATION EXAMPLE 3

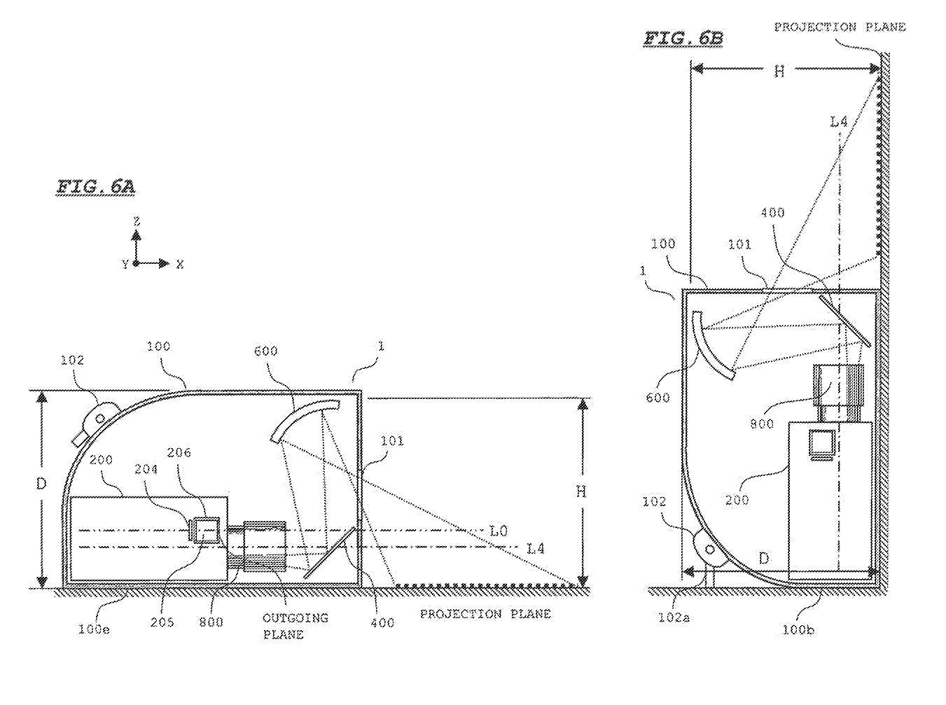

FIGS. 6A and 6B are diagrams showing a configuration of the projector 1 in a modification example 3. FIG. 6A shows the projector 1 installed for “floor projection,” and FIG. 6B shows the projector 1 for “wall projection.”

In the configuration of the modification example 3, unlike the foregoing embodiment, a refractive optical system 800, instead of the rear refractive optical system 300 and the front refractive optical system 500, is arranged only in front of the optical engine 200 and only a curved mirror 600 is arranged above the reflective mirror 400. A light axis L4 of the refractive optical system 800 is perpendicular to the outgoing plane of the dichroic prism 206 and is parallel to the axis L0 perpendicular to the outgoing plane.

In the configuration of the modification example 3, as in the foregoing embodiment, it is possible to shorten the minimum throw distance H and install the projector 1 stably in the both usage patterns of floor projection and wall projection.

In addition, in the configuration of the modification example 3, no refractive optical system is interposed between the reflective mirror 400 and the curved mirror 600, which allows the minimum throw distance H to be shorter than that in the foregoing embodiment. Nevertheless, in the configuration of the modification example 3, the dimension of the projector body is larger in the direction of the light axis L4 of the refractive optical system 800. Therefore, the projector 1 may be installed in a slightly less stable manner for wall projection as compared with the case in the foregoing embodiment, as shown in FIG. 6B.

### MODIFICATION EXAMPLE 4

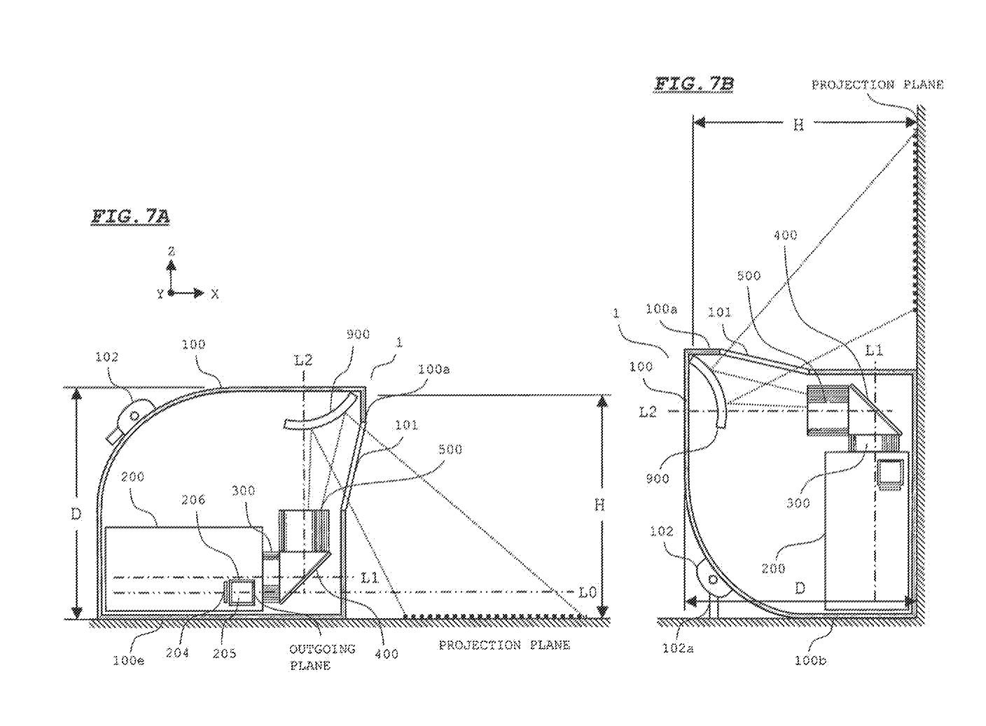

FIGS. 7A and 7B are diagrams showing a configuration of the projector 1 in a modification example 4. FIG. 7A shows the projector 1 installed for “floor projection,” and FIG. 7B shows the projector 1 for “wall projection.”

In the configuration of the modification example 4, a curved mirror 900 having a convex reflecting surface (equivalent to the second reflective optical system of the present invention) is arranged instead of the curved mirror 600. The curved mirror 900 includes an effective reflection area on the front surface 100a side of the light axis L2 of the front refractive optical system 500. The curved mirror 900 may have an aspherical shape, a free-form shape, or a spherical shape.

The liquid crystal panels 203, 204, 205, and the dichroic prism 206 are shifted from the light axis L1 of the rear refractive optical system 300 toward the bottom surface 100e of the cabinet 100.

Image light emitted from the optical engine 200 passes through the rear refractive optical system 300, the reflective mirror 400, and the front refractive optical system 500, and then enters the curved mirror 900. Then, the image light is reflected by the curved mirror 900, and is enlarged and projected onto the projection plane through the projection window 101.

In the configuration of the modification example 4, as in the foregoing embodiment, it is possible to shorten the minimum throw distance H and install the projector 1 stably in the both usage patterns of floor projection and wall projection.

However, in the configuration of the modification example 4, the image light is enlarged immediately after being reflected by the curved mirror 900, and therefore an opening area of the projection window 101 is larger than that in the foregoing embodiment. Since the projection window 101 is generally covered with a window plate made of glass or the like, the larger opening area requires a larger-sized window plate.

### Others

The foregoing embodiment and the modification examples 1 to 4 use the reflective mirror 400, but this is not a definitive arrangement. For example, a reflective prism may be used instead.

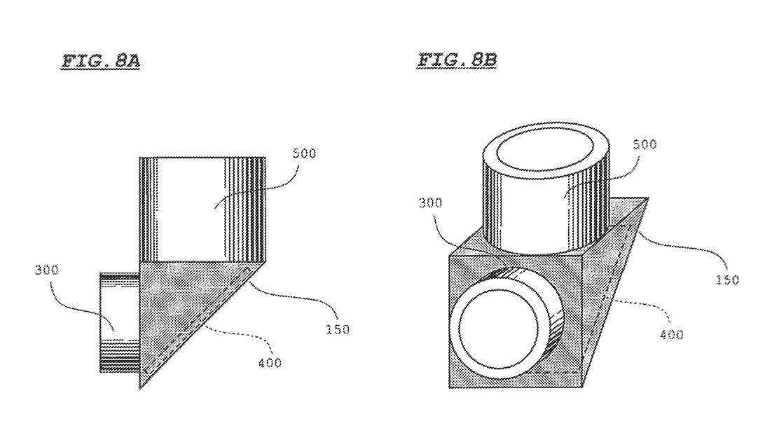

In addition, in the foregoing embodiment and modification examples 1 and 4, the rear refractive optical system 300, the front refractive optical system 500, and the reflective mirror 400 are separated from each other. Alternatively, the three components may be integrated with a mirror frame 150 as shown in FIGS. 8A and 8B, for example. In such a configuration, it is easy to assemble the rear refractive optical system 300, the front refractive optical system 500, and the reflective mirror 400 into the cabinet 100.

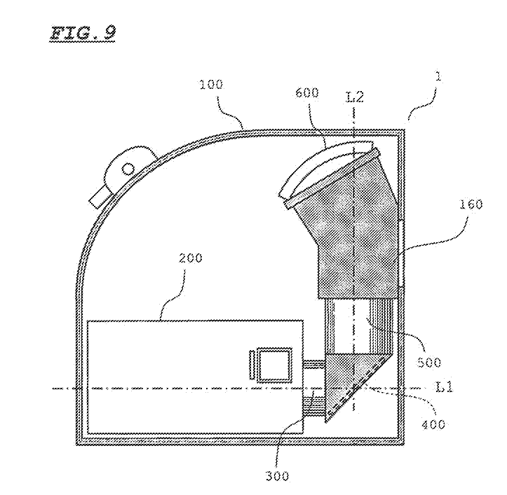

Further, the curved mirror 600 (900), the refractive optical systems 300 and 500 (700 and 800), and the reflective mirror 400 may be integrated with a mirror frame 160, as shown in FIG. 9.

In such a configuration, it is easy to assemble the curved mirror 600 (900), the refractive optical systems 300 and 500 (700 and 800), and the reflective mirror 400 into the cabinet 100.

### Another Modification Example

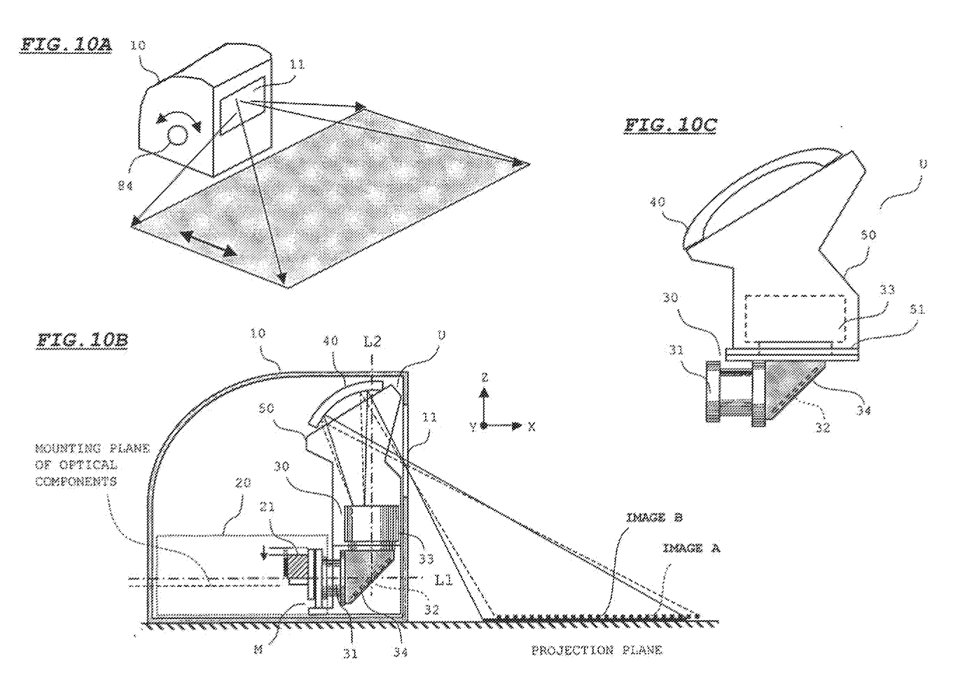

FIGS. 10A, 10B, and 10C are diagrams showing a configuration of a projector in another modification example. FIG. 10A is a perspective view of an outer appearance of the projector, FIG. 10B is a perspective view of an internal structure of the projector as seen from a side, and FIG. 10C is a lateral view of a configuration of a projection optical unit U.

In the projector of this modification example, a position of an image projected onto a projection plane can be adjusted by shifting imagers (liquid crystal panels) vertically. For example, if an image is projected onto a surface on which the projector is installed (floor surface or desktop), the position of the projected image can be adjusted in the front-back direction. For this purpose, the projector has on a side thereof a knob 84 for use in position adjustment as shown in FIG. 10A.

As shown in FIG. 10B, the projector of this modification example includes a casing 10. The casing 10 has a convex curved shape from rear to upper sides thereof. The casing 10 contains an optical engine 20, a refractive optical unit 30, a curved mirror 40 (equivalent to the second reflective optical system of the present invention), and a housing 50.

The optical engine 20 has the same configuration as that of the optical engine 200 in the foregoing embodiment, and also includes an imager unit 21. The imager unit 21 is a component into which three liquid crystal panels for R, G, and B lights and a dichroic prism are integrated.

The refractive optical unit 30 includes a rear refractive optical system 31, a reflective mirror 32 (equivalent to the first reflective optical system of the present invention), and a front refractive optical system 33. The reflective mirror 32 is housed in a mirror case 34. The rear refractive optical system 31, the mirror case 34, and the front refractive optical system 33 are integrated.

The refractive optical unit 30 and the curved mirror 40 are assembled into the housing 50. As shown in FIG. 10C, the refractive optical unit 30 is assembled into the housing 50 in such a manner that the front refractive optical system 33 is housed within the housing 50, and that the mirror case 34 and the rear refractive optical system 31 are exposed downward. In addition, the curved mirror 40 is assembled into an upper end of the housing 50. The housing 50 has flanges 51 on both sides of a lower part thereof. When the refractive optical unit 30 and the curved mirror 40 are assembled into the housing 50, the projection optical unit U is completed.

Configurations and positions of the rear refractive optical system 31, the reflective mirror 32, the front refractive optical system 33, and the curved mirror 40 are identical to those of the rear refractive optical system 300, the reflective mirror 400, the front refractive optical system 500, and the curved mirror 600 in the foregoing embodiment, respectively.

In addition, in the optical engine 20, a mounting plane of optical components is perpendicular to a plane parallel to both the direction of reflection of image light by the reflective mirror 32 and the direction of reflection of image light by the curved mirror 40 (that is, a plane perpendicular to an X-Z plane in the drawing). Here, the mounting plane is parallel to a projection plane of image light. Accordingly, the optical components are scattered in a direction parallel to the projection plane.

The imager unit 21 is held by a shift module M so as to be displaceable in an up-down direction (in a direction perpendicular to the light axis L1). In addition, the projection optical unit U is attached to a base member (described later) constituting the shift module M.

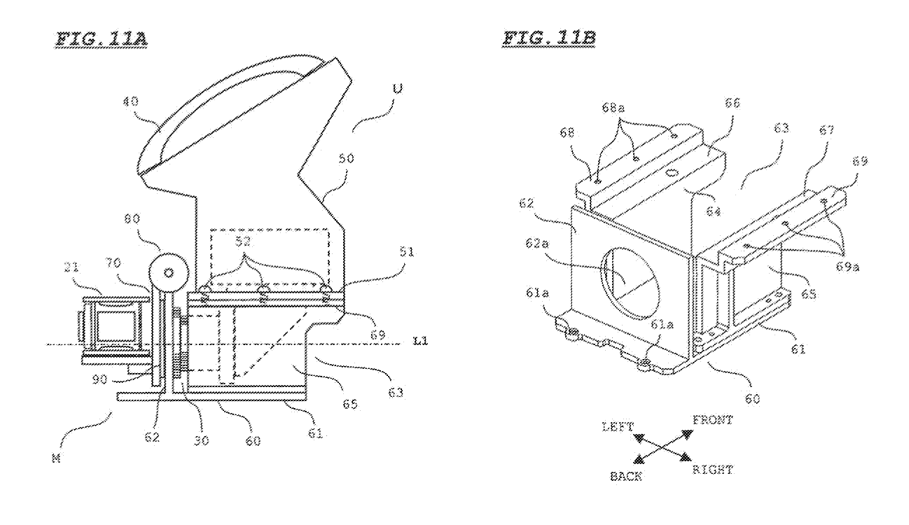

FIGS. 11A and 11B are diagrams showing a configuration of the shift module M, and a structure of attachment of the imager unit 21 and the projection optical unit U to the shift module M. FIG. 11A is a side view of the projection optical unit U attached to a base member 60. FIG. 11B is a perspective view of a configuration of the base member 60.

As shown in FIG. 11A, the shift module M includes the base member 60, a fixing member 70, a displacement mechanism section 80, and a linear guide 90. The fixing member 70, the displacement mechanism section 80, and the linear guide 90 constitute a shift mechanism for shifting the imager unit 21. The shift mechanism with the imager unit 21 and the projection optical unit U are attached together to the base member 60.

As shown in FIG. 11B, the base member 60 includes a pedestal 61, a supporting plate 62 extending vertically (upward) relative to the pedestal 61, and an attachment stand 63 arranged in front of the supporting plate 62.

The pedestal 61 has attachment holes 61a at a rear end on right and left sides thereof. The attachment holes 61a are used to screw the base member 60 into a predetermined position of the casing 10.

The attachment stand 63 is a member separated from the pedestal 61, and is fixed to the pedestal 61 with screws or the like. Alternatively, the attachment stand 63 may be integral with the pedestal 61.

The attachment stand 63 includes a pair of legs 64 and 65. When the projection optical unit U is attached to the base member 60, the rear refractive optical system 31 and the mirror case 34 are housed between the legs 64 and 65.

The legs 64 and 65 have on upper ends thereof holding sections 66 and 67 and flanges 68 and 69, respectively. The holding sections 66 and 67 are lowered in height, to house the bottom portion of the housing 50 by one level than the flanges 68 and 69. In addition, the flanges 68 and 69 have three each screw holes 68a and 69a, respectively.

As shown in FIG. 11A, the projection optical unit U is placed on the attachment stand 63, and is fixed to the attachment stand 63 by tightening the flanges 51 and the flanges 68 and 69. At that time, a leading end of the rear refractive optical system 31 is inserted into an opening 62a of the supporting plate 62.

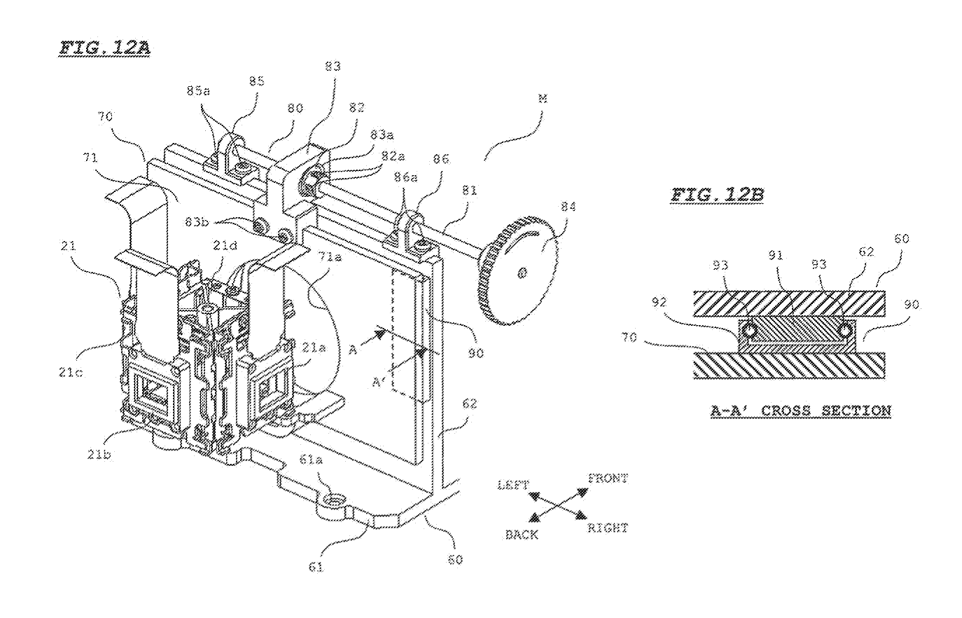

FIGS. 12A and 12B are diagrams showing a configuration of the shift mechanism (the fixing member 70, the displacement mechanism section 80, and the linear guide 90) attached to the base member 60. FIG. 12A is a perspective view of the shift mechanism, and FIG. 12B is a diagram for describing a configuration of the linear guide 90, which is a cross-section view of FIG. 12A taken along A-A′.

The fixing member 70 is attached to the back side of the supporting plate 62 via right and left linear guides 90 (only the right guide is shown in the drawing).

Each of the linear guides 90 includes a rail section 91 vertically extending and a stage section 92 that engages with the rail section 91 to move vertically along the rail section 91. The rail section 91 has a plurality of ball bearings 93 vertically arranged at predetermined intervals, so that the stage section 92 can move smoothly over the rail section 91. The rail section 91 is fixed to the supporting plate 62, and the stage section 92 is fixed to the fixing member 70.

In this manner, the fixing member 70 is supported by the supporting plate 62 in such a manner as to be displaceable vertically along the right and left linear guides 90.

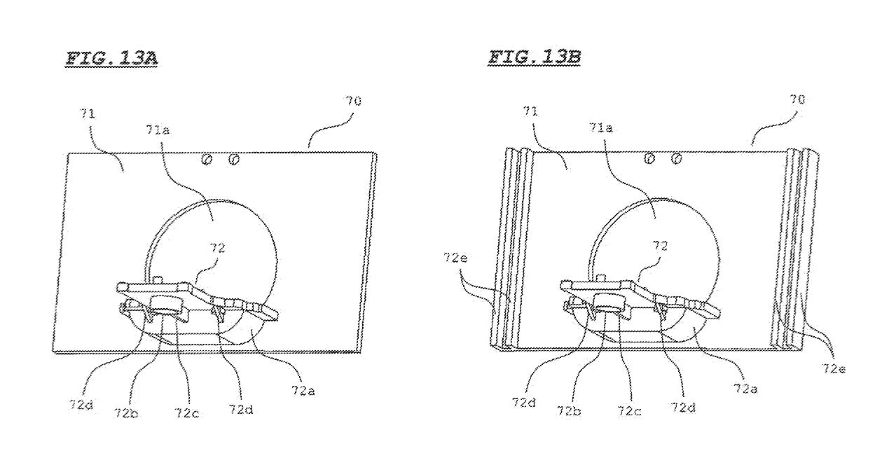

FIGS. 13A and 13B are diagrams showing a configuration of the fixing member 70. FIG. 13A shows a configuration of the fixing member 70 in this modification example, and FIG. 13B shows a transformation example of the fixing member 70.

As shown in FIG. 13A, the fixing member 70 includes a flat plate 71 that is arranged in line with the supporting plate 62. The flat plate 71 has an opening 71a through which image light from the imager unit 21 passes. In addition, the flat plate 71 is integral with a placement section 72 on which the imager unit 21 is placed. A placement surface of the placement section 72 is perpendicular to the flat plate 71 and the supporting plate 62.

The placement section 72 has a receiving part 72a at a base of a back surface thereof. The receiving part 72a is integral with the placement section 72 and the flat plate 71 so as to connect the placement section 72 and the flat plate 71, thereby increasing the base of the placement section 72 in strength. In addition, the placement section 72 has on the back surface thereof an attachment boss 72b for screwing the imager unit 21 at a leading end thereof. Further, the placement section 72 has on the back surface thereof a reinforcement rib 72c connecting the receiving part 72a and the attachment boss 72b. Moreover, the placement section 72 has on the back surface thereof two reinforcement ribs 72d connecting to the receiving part 72a on the both sides of the reinforcement rib 72c. The reinforcement ribs 72c and 72d are formed along a direction in which the placement section 72 projects from the flat plate 71.

In this manner, the placement section 72 is reinforced with the receiving part 72a, the attachment boss 72b, and the reinforcement ribs 72c and 72d. This prevents that the leading end of the placement section 72 is weighted down with the imager unit 21. In addition, the imager unit 21 generates high heat due to irradiated light. Accordingly, the placement section 72 is prone to reach a high temperature, but the foregoing reinforcements can prevent thermal deformation of the placement section 72.

As shown in FIG. 13B, the flat plate 71 may have a vertically extending reinforcement rib 72e. This prevents the flat plate 71 from being deformed with an upper part inclined frontward or backward due to weight or heat generation of the imager unit 21. In this transformation example, the flat plate 71 has two each reinforcement ribs 72e on right and left ends.

Returning to FIGS. 12A and 12B, the imager unit 21 is placed on the placement section 72 of the fixing member 70. The imager unit 21 is formed by integrating three liquid crystal panels 21a, 21b, and 21c and a dichroic prism 21d, as described above.

The fixing member 70 is shifted by the displacement mechanism section 80 in an up-down direction, that is, in a direction perpendicular to the light axis L1 of the rear refractive optical system 31.

The displacement mechanism section 80 is constituted by a shaft 81, an eccentric cam 82, a displacement member 83, and the knob 84, and two shaft bearings 85 and 86.

The eccentric cam 82 is fixed to the shaft 81 with two screws 82a. The shaft 81 is rotatably supported by the shaft bearings 85 and 86 on both sides of the eccentric cam 82. The shaft bearings 85 and 86 are fixed to an upper end of the supporting section 62 with two screws 85a and 86a, respectively.

The eccentric cam 82 is inserted into a cam hole 83a of the displacement member 83. The eccentric cam 82 is formed in such a manner as to obtain a desired displacement amount of the imager unit 21. The displacement member 83 is fixed to an upper end of the flat plate 71 with two screws 83b.

The shaft bearings 85 and 86 may be integral with the supporting plate 62. In addition, the displacement member 83 may be integral with the flat plate 71.

The knob 84 is attached to one end of the shaft 81. The knob 84 is exposed on an outer surface of the casing 10 (refer to FIG. 10A) such that a user can turn the knob 84.

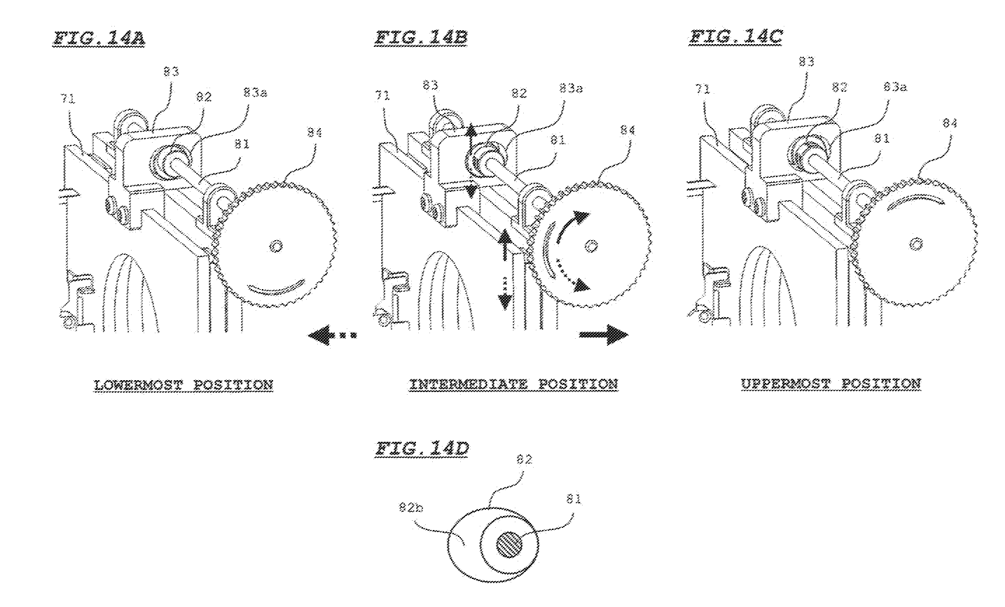

FIGS. 14A, 14B, 14C, and 14D are diagrams for describing a shift operation by the shift mechanism.

For example, when a user turns the knob 84 in an intermediate position shown in FIG. 14B clockwise (in the direction of solid arrow), a wide section 82b of the eccentric cam 82 (refer to FIG. 14D) moves upward to displace the displacement member 83 upward, thereby displacing the flat plate 71 (fixing member 70) upward, as shown in FIG. 14C. Accordingly, the imager unit 21 on the placement section 72 shifts upward.

Meanwhile, when a user turns the knob 84 in the intermediate position counterclockwise (in the direction of dashed arrow), the wide section 82b of the eccentric cam 82 moves downward to displace the displacement member 83 downward, thereby displacing the flat plate 71 (fixing member 70) downward. Accordingly, the imager unit 21 on the placement section 72 shifts downward.

The displacement mechanism section 80 is provided with a lock device (not shown) for locking the knob 84 so as not to turn. After shifting the imager unit 21 to a desired position, a user locks the knob 84 with the lock device. This allows the imager unit 21 to be fixed at an arbitrary position. Alternatively, the lock device may be configured to lock any component other than the knob 84, for example, the shaft 81 or the fixing plate 70. In addition, the shaft 81 may be electrically driven by a motor or the like, instead of being turned by manual operation of the knob 84.

Spot sizes of R, G, and B lights radiated to the liquid crystal panels 21a, 21b, and 21c are set wider than the effective display planes of the liquid crystal panels, so that the liquid crystal panels can be entirely irradiated with light even when the imager unit 21 is vertically displaced.

Accordingly, as shown in FIG. 10B, the image light generated at the optical engine 20 passes through the rear refractive optical system 31, the reflective mirror 32, and the front refractive optical system 33, and then is entered into the curved mirror 40. Then, the image light is reflected by the curved mirror 40, and is enlarged and projected onto a floor surface through the projection window 11.

At that time, the position of the projected image can be adjusted by shifting the imager unit 21. For example, when the knob 84 is turned to shift the imager unit 21 from top down, the imager unit 21 comes closer to the light axis L1. Accordingly, a key light position of upper and lower ends of the image light emitted from the front refractive optical system 33 (hereinafter, “key light position of upper and lower ends” will be referred to as “light position”) changes from a light position shown by a dashed line to a light position shown by a solid line in the drawing. Specifically, the light position of the image light from the front refractive optical system 33 comes closer to the light axis L2, and therefore an incident position of the image light on the curved mirror 40 is shifted forward. Accordingly, the light position of the image light reflected by the curved mirror 40 and traveling toward the floor surface is shifted toward the projector (Image A shifts to Image B as shown in the drawing).

According to this modification example, as the foregoing, it is possible to shorten the minimum throw distance, and it is also possible to install the projector stably in the both usage patterns of floor projection and wall projection, as in the foregoing embodiment.

In addition, according to this modification example, the position of a projected image can be adjusted simply by shifting the imager unit 21 without having to move the projector.

### Modification Example of the Optical Engine

In the foregoing embodiment, the optical engine 200 uses the transmissive liquid crystal panels 203, 204, and 205 as imagers. Alternatively, the optical engine 200 may use liquid crystals on silicon (LCOSs) that is reflective liquid crystal panels or digital micro mirror devices (DMDs) that is MEMS devices as imagers, as shown in configuration examples 1 to 5 described below. In addition, the projectors in the foregoing modification examples 1 to 4 and another modification example may use the imagers in the configuration examples 1 to 5.

### CONFIGURATION EXAMPLE 1

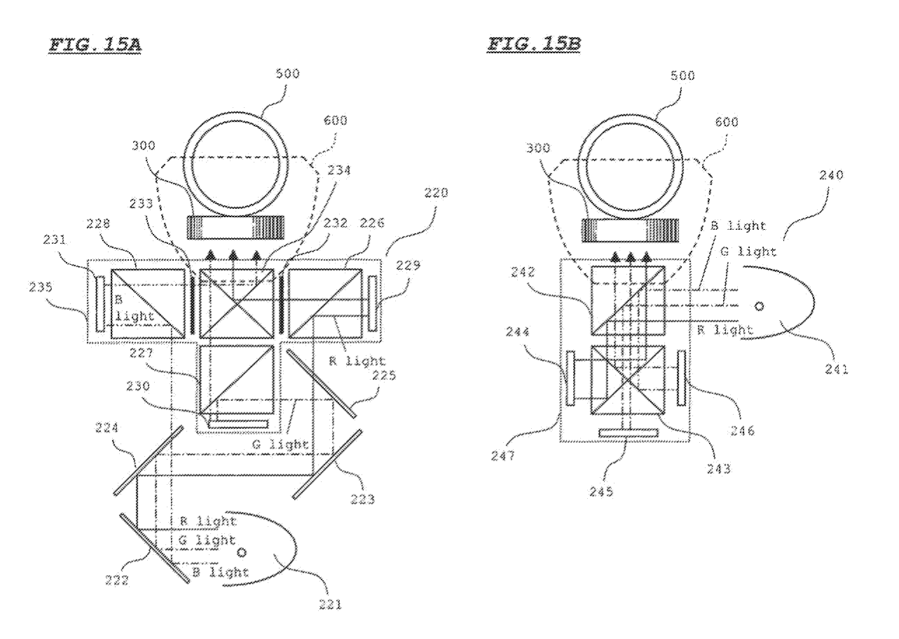

FIG. 15A is a diagram showing a configuration of an optical engine 220 in the configuration example 1. This configuration example uses LCOSs as imagers.

The optical engine 220 includes a light source 221, two mirrors 222, 223 and two dichroic mirrors 224, 225 constituting a light-guiding optical system, and an imager unit 235 modulating and combining light from the light-guiding optical system.

The imager unit 235 is formed by integrating three polarized beam splitters (PBSs) 226, 227, 228, three LCOSs 229, 230, 231, and two λ/2 plates 232, 233, a dichroic prism 234, and polarizers (not shown) arranged on incident planes of the PBSs 226, 227, 228.

The light source 221 includes a lamp, a fly-eye lens, a PBS array, and a condenser lens. Light emitted from the light source 221 is uniformed in a direction of polarization by the PBS array.

The light emitted from the light source 221 is reflected by the mirror 222 and entered into the dichroic mirror 224. Out of the entered light, the dichroic mirror 224 reflects R and G lights and lets a B light pass through.

The R and G lights reflected by the dichroic mirror 224 are reflected by the mirror 223 and entered into a dichroic mirror 225. The dichroic mirror 225 reflects the G light and lets the R light pass through.

The R light having passed through the dichroic mirror 225 is cleared of an unnecessary P polarization component by the polarizer (not shown), and is set as S polarized light with respect to the PBS 226. The R light is then reflected by the PBS 226 and is radiated to the LCOS 229. The LCOS 229 modulates and reflects the R light in accordance with an image signal. Specifically, the LCOS 229 turns the direction of polarization of the R light for each of pixels constituting an effective display plane of the LCOS 229.

Accordingly, the modulated R light passes through the PBS 226 according to the polarization direction thereof, and passes through the λ/2 plate 232, as a result, the polarization direction of the modulated R light turns, and then the modulated R light enters the dichroic prism 234.

In addition, the G light reflected by the dichroic mirror 225 is cleared of an unnecessary P polarization component by the polarizer (not shown), and is set as S polarized light with respect to the PBS 227. The G light is then reflected by the PBS 227 and is radiated to the LCOS 230. The LCOS 230 modulates and reflects the G light in accordance with an image signal.

Accordingly, the modulated G light passes through the PBS 227 in the direction of polarization, and enters the dichroic prism 234.

Meanwhile, the B light having passed through the dichroic mirror 224 is cleared of an unnecessary P polarization component by a polarizer (not shown), and is set as S polarized light with respect to the PBS 228. The B light is then reflected by the PBS 228 and is radiated to the LCOS 231. The LCOS 231 modulates and reflects the B light in accordance with an image signal.

Accordingly, the modulated B light passes through the PBS 228 in accordance with the polarization direction, and passes through the λ/2 plate 233, as a result, the polarization direction of the modulated B light turns, and then the modulated B light enters the dichroic prism 234.

When the R and B lights are reflected by the dichroic prism 234 and the G light passes through the dichroic prism 234, these three lights are combined and entered as image light into the rear refractive optical system 300.

The R, G, and B lights that have been modulated by the LCOSs 229, 230, and 231 and have passed through the PBSs 226, 227, and 228, are each set as P polarized light with respect to the dichroic prism 234. In this case, S polarized light is higher in reflection rate in a wider wavelength band due to characteristics of a dielectric multilayer film of the dichroic prism 234. Therefore, in the dichroic prism 234, the G light is high in transmission efficiency, but the R and B lights are low in reflection efficiency if the R and B lights remain P polarized lights. Therefore, the optical engine 220 of FIG. 15A lets the R and B lights pass through the λ/2 plates 232 and 233 so as to turn into S polarized lights, thereby enhancing reflection efficiencies of the R and B lights on the dichroic prism 234.

In this configuration example, as in the foregoing embodiment the optical components of the optical engine 220 such as the imager unit 235 are arranged in a predetermined layout on the mounting plane of the optical component shown in FIG. 1A. Accordingly, the optical components are scattered in a direction parallel to the projection plane (X-Y plane) shown in FIG. 2A.

Accordingly, as in the foregoing embodiment, it is possible to shorten the minimum throw distance even if the optical engine 200 in the foregoing embodiment is replaced by the optical engine 220 in this configuration example. In addition, it is possible to install the projector stably in the both usage patterns of floor projection and wall projection.

### CONFIGURATION EXAMPLE 2

FIG. 15B is a diagram showing a configuration of an optical engine 240 in the configuration example 2. In this configuration example, LCOSs are used as imagers as in the configuration example 1.

The optical engine 240 includes a light source 241 and an imager unit 247 modulating and combining light from the light source.

The imager unit 247 is formed by integrating a polarized beam splitter (PBS) 242, a dichroic prism 243, three LCOSs 244, 245, and 246, and a polarizer (not shown) arranged on an incident plane of the PBS 242.

The light source 241 includes a lamp, a fly-eye lens, a PBS array, and a condenser lens. Light emitted from the light source 241 is uniformed in a direction of polarization by the PBS array.

The light emitted from the light source 241 is cleared of an unnecessary P polarization component by the polarizer (not shown), and is set as S polarized light with respect to the PBS 242. The light is then reflected by the PBS 242 and is entered into the dichroic prism 243. Out of the light entered into the dichroic prism 243, R and B lights are reflected by the dichroic prism 243 and radiated to the LCOSs 244 and 246, respectively. Meanwhile, a G light passes through the dichroic prism 243 and is radiated to the LCOS 245.

The R, G, and B lights that have been modulated by the LCOSs 244, 245, and 246, are entered again into the dichroic prism 243 and combined. After that, the combined light passes through the PBS 242 in the direction of polarization, and then enters as image light into the rear refractive optical system 300.

In this configuration example, the optical components of the optical engine 240 such as the imager unit 247 are arranged in a predetermined layout on the mounting plane shown in FIG. 1A. Accordingly, the optical components are scattered in a direction parallel to the projection plane (X-Y plane) shown in FIG. 2A.

Accordingly, as in the foregoing embodiment, it is possible to shorten the minimum throw distance even if the optical engine 200 in the foregoing embodiment is replaced by the optical engine 240 in this configuration example. In addition, it is possible to install the projector stably in the both usage patterns of floor projection and wall projection.

### CONFIGURATION EXAMPLE 3

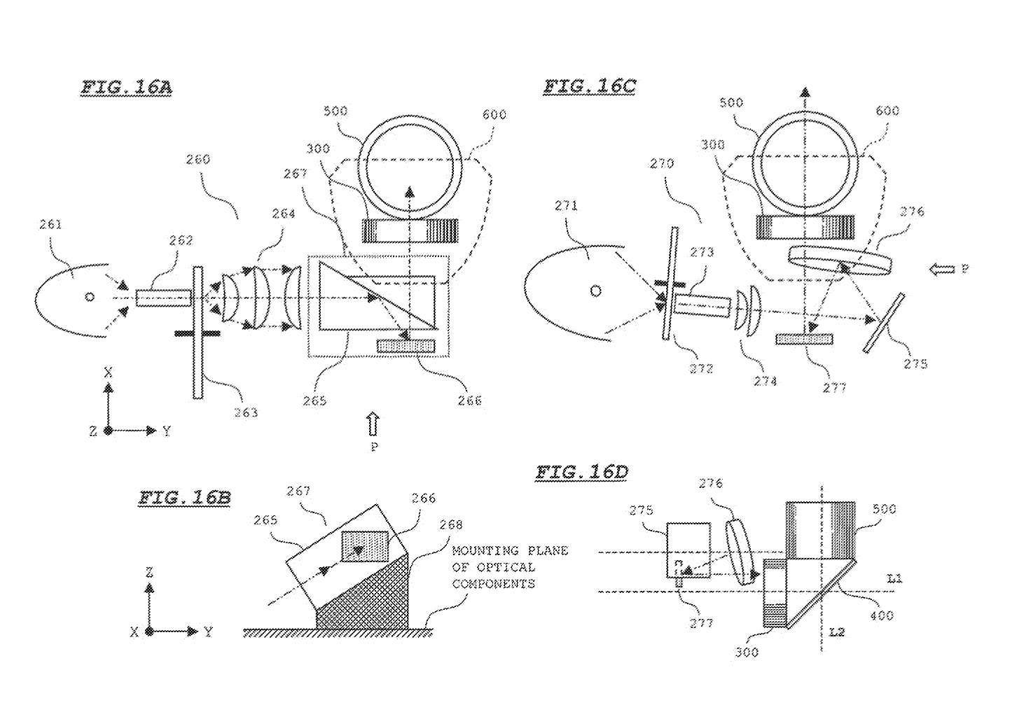

FIG. 16A is a diagram showing a configuration of an optical engine 260 in the configuration example 3. FIG. 16B is a diagram showing a mounting state of an imager unit 267 on a mounting plane, as seen in the direction of arrow P in FIG. 16A. In this configuration example, a single-plate DMD is used as an imager.

The optical engine 260 includes a light source 261, a rod integrator 262, a color wheel 263, a relay lens group 264, and an imager unit 267. The rod integrator 262, the color wheel 263, and the relay lens group 264 constitute a light-guiding optical system. The imager unit 267 modulates and combines light from the light-guiding optical system.

The imager unit 267 is formed by integrating a total internal reflection (TIR) prism 265 and a single-plate DMD 266.

Light emitted from the light source 261 is unified in illumination distribution by the rod integrator 262, and is entered into the color wheel 263. The color wheel 263 includes red, green, and blue filters that are switched in turn in a short time. The red filter lets only a R light pass through, the green filter lets only a G light pass through, and the blue filter lets only a B light pass through.

The color wheel may also include white, yellow, cyan, and magenta filters as well as red, green, and blue ones.

The R, G, and B lights having passes through the color wheel 263 with time differences, pass through the relay lens group 264, and then are reflected by the TIR prism 265 and radiated to the DMD 266. Then, after being modulated by the DMD 266, the lights pass through the TIR prism 265 and enter the rear refractive optical system 300.

Since the filters in the color wheel 263 are switched at a high speed, images of the R, G, and B lights are combined and projected as one image onto a screen.

In this configuration example, as in the foregoing embodiment, optical components of the optical engine 260 such as the imager unit 267 are mounted in a predetermined layout on the mounting plane of the optical components shown in FIG. 1A. Accordingly, the optical components are scattered in a direction parallel to the projection plane (X-Y plane) shown in FIG. 2A.

As shown in FIG. 16B, the imager unit 267 is held on the mounting plane by a holding section 268 in such a manner that a longer side of the DMD 266 is parallel to the mounting plane and the TIR prism 265 is tilted relative to the mounting plane in the direction of Y axis. The TIR prism 265 is tilted because it is needed to irradiate light onto the DMD 266 in an oblique direction due to a structure of a micro mirror (moving mirror) constituting the DMD 266. In accordance with the tilt of the TIR prism 265, other optical components such as the light source 261 may be tilted as appropriate relative to the mounting plane. However, even if the TIR prism 265 and the like are held so as to be tilted, the mounting plane of the optical components is unchangeably perpendicular to the X-Z plane of FIG. 1.

Accordingly, it is possible to shorten the minimum throw distance as in the foregoing embodiment, even if the optical engine 200 of the foregoing embodiment is replaced by the optical engine 260 of this configuration example. In addition, it is possible to install the projector stably in the both usage patterns of floor projection and wall projection.

Alternatively, it is conceivable that the mounting plane of the optical components is tilted in accordance with the tilt of the TIR prism 265 and other optical components. Even in this case, however, the optical components are scattered within the projector in a direction parallel to the projection plane. Therefore, it is possible to install the projector stably in the both usage patterns of floor projection and wall projection.

### CONFIGURATION EXAMPLE 4

FIGS. 16C and 16D are diagrams showing a configuration of an optical engine 270 in the configuration example 4. FIG. 16C is a top view, and FIG. 16D is a side view as seen in the direction of arrow P in FIG. 16C. In FIG. 16D, an arrangement of the light source 271 to the relay lens group 274 is omitted.

In this configuration example, a single-plate DMD is used as an imager as in the configuration example 3.

The optical engine 270 includes a light source 271, a color wheel 272, a rod integrator 273, a relay lens group 274, a plane mirror 275, a concave mirror 276, and a single-plate DMD 277.

Light emitted from the light source 271 is entered into the color wheel 272. The color wheel 272 includes red, green, and blue filters that are switched in turn in a short time, as in the color wheel 263 of the configuration example 3.

The color wheel may also include white, yellow, cyan, and magenta filters as well as red, green, and blue ones.

The R, G, and B lights having passes through the color wheel 272 with time differences are unified in illumination distribution by the rod integrator 273, and then are emitted from the relay lens 274.

As shown in FIG. 16D, the DMD 277 is shifted upward with respect to the light axis L1 of the rear refractive optical system 300. The plane mirror 275 is tilted relative to a light axis of the light source 271 so that light from the light source 271 enters the DMD 277 at a predetermined incident angle. In addition, the concave mirror 276 is tilted relative to the light axis of the light source 271 and the light axis L1 of the rear refractive optical system 300, so that light from the light source 271 enters the DMD 277 at a predetermined incident angle, and the concave mirror 276 is eccentrically arranged.

The light (R, G, and B lights) emitted from the relay lens group 274 is reflected by the plain mirror 275, and then is reflected by the concave mirror 276 and radiated to the DMD 277. Then, after being modulated by the DMD 277, the light is entered into the rear refractive optical system 300.

Since the filters in the color wheel 272 are switched at a high speed, images of the R, G, and B lights are combined and projected as one image onto a screen.

In this configuration example, as in the foregoing embodiment, optical components of the optical engine 270 such as the DMD 277 are mounted in a predetermined layout on the mounting plane of the optical components shown in FIG. 1A. Accordingly, the optical components are scattered in a direction parallel to the projection plane (X-Y plane) shown in FIG. 2A.

Some of the optical components such as the concave mirror 276 are tilted relative to the mounting plane. However, even if the concave mirror 276 and the like are held so as to be tilted, the mounting plane of the optical components is unchangeably perpendicular to the X-Z plane of FIG. 1.

Accordingly, it is possible to shorten the minimum throw distance as in the foregoing embodiment, even if the optical engine 200 of the foregoing embodiment is replaced by the optical engine 270 of this configuration example. In addition, it is possible to install the projector stably in the both usage patterns of floor projection and wall projection.

### CONFIGURATION EXAMPLE 5

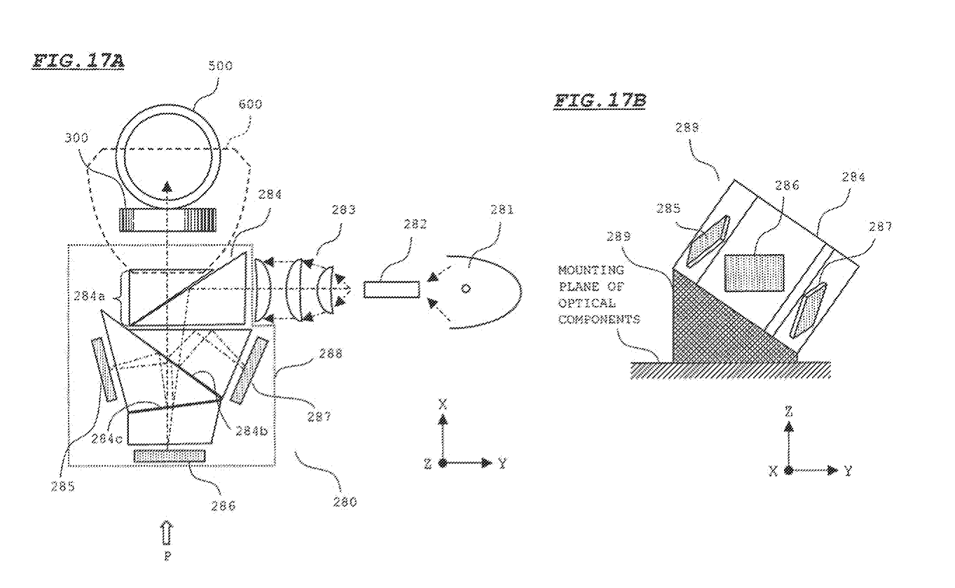

FIG. 17A is a diagram showing a configuration of an optical engine 280 in the configuration example 5. FIG. 17B is a diagram showing a mounting state of an imager unit 288 on the mounting plane, as seen in the direction of arrow P in FIG. 17A. This configuration example uses a three-plate DMD.

FIGS. 17A and 17B are conceptual diagrams for describing light paths of color lights in the optical engine using a three-plate DMD. Therefore, it is to be noted that a three-dimensional layout of a light source 281, a rod integrator 282, a relay lens group 283, a three-DMD color separating/combining prism 284, and a TIR prism 284a is actually different from that shown in FIGS. 17A and 17B.

The optical engine 280 includes a light source 281, a rod integrator 282 and a relay lens group 283 constituting a light-guiding optical system, and an imager unit 288 modulating/combining light from the light-guiding optical system.

The imager unit 288 is formed by integrating the color separating/combining prism 284 for three-digital micro-mirror device (DMD), and a three-plate DMD 285, 286, and 287.

Light emitted from the light source 281 is unified in illumination distribution by the rod integrator 282, and then is entered into the TIR prism 284a of the three-DMD color separating/combining prism 284 via the relay lens group 283. The details of a configuration of the three-DMD color separating/combining prism 284 are described in JP 2006-79080 A, for example.

The light entered into the three-DMD color separating/combining prism 284 is separated by dichroic films 284b and 284c constituting the three-DMD color separating/combining prism 284. The R light enters an R light DMD 285, the G light enters a G light DMD 286, and the B light enters a B light DMD 287. The R, G, and B lights modulated by the DMDs 285, 286, and 287 are unified in light path by the three-DMD color separating/combining prism 284, and image light with a combination of the color lights is entered from the TIR prism 284a into the rear refractive optical system 300.

In this configuration example, as in the foregoing embodiment, optical components of the optical engine 280 such as the imager unit 288 are mounted in a predetermined layout on the mounting plane of the optical components shown in FIG. 1A. Accordingly, the optical components are scattered in a direction parallel to the projection plane (X-Y plane) shown in FIG. 2A.

As shown in FIG. 17B, the imager unit 288 is held on the mounting plane by a holding section 289 in such a manner that the G light DMD 286 is parallel to the mounting plane and the three-DMD color separating/combining prism 284 is tilted relative to the mounting plane in the Y-axis direction. The R light DMD 285 and the B light DMD 287 are integrated with the three-DMD color separating/combining prism 284 in such a manner as to have a predetermined amount of tilt relative to the three-DMD color separating/combining prism 284. This is for the purpose of allowing light to be radiated in an oblique direction relative to micro mirrors of the DMDs 285, 286, and 287, as in the configuration example 3.

Further, in accordance with the tilt of the three-DMD color separating/combining prism 284, other optical components such as the light source 281 may be tilted relative to the mounting plane at a predetermined angle to the three-DMD color separating/combining prism 284, by mounting a folding mirror as appropriate. However, if the three-DMD color separating/combining prism 284 and the like are held so as to be tilted, the mounting plane is unchangeably perpendicular to the X-Z plane in FIGS. 1A and 1B.

Accordingly, it is possible to shorten the minimum throw distance as in the foregoing embodiment, even if the optical engine 200 of the foregoing embodiment is replaced by the optical engine 280 of this configuration example. In addition, it is possible to install the projector stably in the both usage patterns of floor projection and wall projection.

In this configuration example, the mounting plane of the optical components may be tilted in accordance with the tilt of the three-DMD color separating/combining prism 284 and other optical components, as in the configuration example 3. However, the optical components are unchangeably scattered within the projector in a direction parallel to the projection plane. Even in this case, it is possible to install the projector stably in the both usage patterns of floor projection and wall projection.

### Others

If the optical engines in the configuration examples 1 to 5 are applied to the projector in another modification example shown in FIGS. 10A to 14D, the imager units 235, 247, 267, and 288 in the configuration examples 1 to 3 and 5 are each placed on the placement section 72 of the fixing member 70 and are shifted vertically by the shift mechanism. In the configuration example 4, the DMD 277 is placed on the placement section 72 and is shifted vertically by the shift mechanism. In addition, as in another modification example, the spot sizes of R, G, and B lights radiated to the imagers (LCOSs or DMDs) are set larger than effective display planes of the imagers so that light can be radiated to the effective display planes even when the imager modules or the like in the configuration examples move vertically.

In addition, the foregoing embodiment and modification examples use a lamp light source having a reflector as a light source. However, the light source is not limited to this and may be LEDs or laser diodes instead. In this case, in the optical engines with a single-plate DMD in the configuration examples 3 and 4, LEDs or laser diodes as a light source may be illuminated on for each color in a time-division manner, instead of using a color wheel.

Although the embodiment and modification examples of the present invention are described above, the present invention is not limited to by these embodiment and examples. Besides, the embodiment of the present invention can be further modified in various manners within the scope of technical ideas shown in the claims.

What is claimed is:

1. A projection display device, comprising:
an optical engine that emits image light modulated in accordance with an image signal in a direction parallel to a projection plane or in a direction tilted relative to the projection plane at a predetermined angle;
a first reflective optical system that reflects the image light in a first direction away from the projection plane;
a second reflective optical system that reflects the image light reflected by the first reflective optical system in a second direction away from the optical engine and closer to the projection plane, thereby to enlarge and project the image light onto the projection plane; and
a refractive optical system that is interposed between the optical engine and the second reflective optical system, wherein
the refractive optical system is divided into a first refractive optical system interposed between the optical engine and the first reflective optical system, and a second refractive optical system interposed between the first reflective optical system and the second reflective optical system, and
the optical engine is arranged in such a manner that a mounting plane of optical components is almost perpendicular to a plane parallel to both of the first and second directions and is almost parallel to the projection plane.

2. The projection display device according to claim 1, wherein
the second reflective optical system has a concave reflecting surface and converges the image light at minimum near the projection window for guiding the image light outward.

3. A projection display device, comprising:
an optical engine that emits image light modulated in accordance with an image signal in a direction parallel to a projection plane or in a direction tilted relative to the projection plane at a predetermined angle;
a first reflective optical system that reflects the image light in a first direction away from the projection plane;
a second reflective optical system that reflects the image light reflected by the first reflective optical system in a second direction away from the optical engine and closer to the projection plane, thereby to enlarge and project the image light onto the projection plane; and
a refractive optical system that is interposed between the optical engine and the second reflective optical system, wherein
the refractive optical system is divided into a first refractive optical system interposed between the optical engine and the first reflective optical system, and a second refractive optical system interposed between the first reflective optical system and the second reflective optical system, and
optical components constituting the optical engine are scattered in a direction that is almost perpendicular to a plane parallel to both of the first and second directions and is almost parallel to the projection plane.

4. A projection display device, comprising:
an optical engine that emits image light modulated by a micro mirror element in accordance with an image signal in a direction parallel to a projection plane;
a first reflective optical system that reflects the image light in a first direction away from the projection plane;
a second reflective optical system that reflects the image light reflected by the first reflective optical system in a second direction away from the optical engine and closer to the projection plane, thereby to enlarge and project the image light onto the projection plane; and
a refractive optical system interposed between the optical engine and the second reflective optical system, wherein
the refractive optical system is divided into a first refractive optical system that is interposed between the optical engine and the first reflective optical system, and a second refractive optical system that is interposed between the first reflective optical system and the second reflective optical system, and
the micro mirror element is arranged such that a longer side thereof is almost perpendicular to a plane parallel to both of the first and second directions and is almost parallel to the projection plane.
